(19) United States
(12) Patent Application Publication
(10) Pub. No.: US 2025/0392987 A1
(43) Pub. Date: Dec. 25, 2025

(54) Power Consumption Control of a Receiver

(71) Applicant: Telefonaktiebolaget LM Ericsson (publ), Stockholm (SE)

(72) Inventors: Sina Maleki, Malmö (SE); Andres Reial, Höllviken (SE); Gang Zou, Lund (SE); Niklas Andgart, Södra Sandby (SE)

(21) Appl. No.: 18/876,398

(22) PCT Filed: Jun. 21, 2022
(86) PCT No.: PCT/EP2022/066823

§ 371 Date: Dec. 18, 2024

(51) Int. Cl. H04W 52/02; H04L 1/00; H04L 27/26

(52) U.S. Cl. CPC H04W 52/0219; H04L 1/0003; H04L 27/26025

(57) ABSTRACT

Methods are disclosed for power consumption control of a receiver configurable in different operational modes. Each of the operational modes is associated with a respective power consumption of the receiver. At least two of the respective power consumptions are different, and at least two of the operational modes have different hardware settings. One method comprises selecting one of the operational modes for an upcoming reception occasion. The selection of the operational mode is based on one or more selection parameters which include an expected modulation and coding scheme (MCS) for the upcoming reception occasion. One method comprises determining a mapping scheme from one or more selection parameters to a collection of operational modes, wherein the one or more selection parameters include an expected modulation and coding scheme (MCS), and providing the mapping scheme for use by the receiver in selecting one of the operational modes for a reception occasion. Corresponding computer program product, apparatuses, receiver, communication device, and server node are also disclosed.

### TECHNICAL FIELD

The present disclosure relates generally to the field of wireless communication. More particularly, it relates to power consumption control of a receiver for wireless communication.

### BACKGROUND

Power consumption is a general concern for communication devices. This concern is particularly relevant for communication devices powered by a source with limited and relatively low available energy (e.g., non-chargeable battery), and for communication devices powered by a fluctuating energy availability (e.g., energy harvesting).

Typically, power consumption for a receiver can be lowered by using less complex processing. However, this often entails degraded reception performance (e.g., increased probability of missed detection, and/or increased probability of error in demodulation/decoding).

Therefore, there is a need for approaches to power consumption control for receivers. Preferably, the approaches would provide reduced power consumption compared to other approaches, while maintaining acceptable reception performance.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for power consumption control of a receiver configurable in different operational modes, wherein each of the operational modes is associated with a respective power consumption of the receiver, wherein at least two of the respective power consumptions are different, and wherein at least two of the operational modes have different hardware settings. The method comprises selecting one of the operational modes for an upcoming reception occasion, wherein the selection of the operational mode is based on one or more selection parameters which include an expected modulation and coding scheme (MCS) for the upcoming reception occasion.

In some embodiments, the expected MCS is either of: a known MCS, a MCS of a previous reception occasion, and a worst case MCS.

In some embodiments, the known MCS is a predefined MCS for a known channel type of the upcoming reception occasion.

In some embodiments, the one or more selection parameters further include one or more of: an expected numerology for the upcoming reception occasion, an expected sub-carrier spacing for the upcoming reception occasion, and an expected cyclic prefix length for the upcoming reception occasion.

In some embodiments, the one or more selection parameters further include a mobility state of the receiver.

In some embodiments, the one or more selection parameters further include an expected signal quality for the upcoming reception occasion.

In some embodiments, the method further comprises performing measurements to determine the expected signal quality.

In some embodiments, at least two of the operational modes define different numbers of reference signals to be used for synchronization in preparation for the upcoming reception occasion, and/or different reference signal bandwidths to be used for synchronization in preparation for the upcoming reception occasion.

In some embodiments, each of the operational modes has an expected synchronization error, wherein the one or more selection parameters are associated with an acceptable synchronization error, and wherein the expected synchronization error of the selected operational mode is smaller than, or equal to, the acceptable synchronization error of the one or more selection parameters.

In some embodiments, selecting one of the operational modes comprises determining a collection of operational modes with expected synchronization error smaller than, or equal to, the acceptable synchronization error of the one or more selection parameters, and selecting one of the operational modes of the collection.

In some embodiments, selecting one of the operational modes of the collection comprises selecting the operational mode which is associated with a lowest power consumption in the collection, and/or selecting one of the operational modes of the collection which has a power consumption that is lower than a power consumption threshold.

A second aspect is a method for power consumption control of a receiver configurable in different operational modes, wherein each of the operational modes is associated with a respective power consumption of the receiver, wherein at least two of the respective power consumptions are different, and wherein at least two of the operational modes have different hardware settings. The method comprises determining a mapping scheme from one or more selection parameters to a collection of operational modes, wherein the one or more selection parameters include an expected modulation and coding scheme (MCS), and providing the mapping scheme for use by the receiver in selecting one of the operational modes for a reception occasion.

In some embodiments, the mapping scheme comprises a mapping from selection parameters to an acceptable synchronization error, and a mapping from operational mode to an expected synchronization error.

In some embodiments, the method further comprises determining the respective power consumption of the receiver for each of the operational modes, and providing an indication of the respective power consumption for use by the receiver.

In some embodiments of either, or both, of the first and second aspects, the hardware settings include one or more of: local oscillator settings, phase-locked loop settings, analog-to-digital converter settings, antenna branch settings, low noise amplifier settings, clock rate settings, and baseband processing speed settings.

In some embodiments of either, or both, of the first and second aspects, a first operational mode has a first respective power consumption which is lower than a second respective power consumption of a second operational mode. For example, the first respective power consumption of the first operational mode may be lower than the second respective power consumption of the second operational mode responsive to one or more of: a local oscillator stability being lower for the first operational mode than for the second operational mode, a local oscillator phase noise being higher for the first operational mode than for the second operational mode, a phase-locked loop precision being lower for the first operational mode than for the second operational mode, an analog-to-digital converter dynamic range being lower for the first operational mode than for the second operational mode, an analog-to-digital converter sampling rate being lower for the first operational mode than for the second operational mode, an analog-to-digital converter resolution being lower for the first operational mode than for the second operational mode, a number of active antenna branches being lower for the first operational mode than for the second operational mode, a low noise amplifier linearity being lower for the first operational mode than for the second operational mode, a low noise amplifier noise figure being higher for the first operational mode than for the second operational mode, a low noise amplifier sensitivity being lower for the first operational mode than for the second operational mode, a clock rate being lower for the first operational mode than for the second operational mode, and a baseband processing speed being lower for the first operational mode than for the second operational mode.

In some embodiments of either, or both, of the first and second aspects, the reception occasion is preceded by an inactivity mode of the receiver.

In some embodiments of either, or both, of the first and second aspects, the reception occasion comprises one or more of: a paging occasion, a random access resource, and a system information resource.

In some embodiments of either, or both, of the first and second aspects, the reception occasion comprises two or more physical channels.

In some embodiments of either, or both, of the first and second aspects, associations between the one or more selection parameters and the operational modes are determined by one or more of: separate handling of the two or more physical channels, averaging over the two or more physical channels, and worst case analysis over the two or more physical channels.

In some embodiments of either, or both, of the first and second aspects, the two or more physical channels comprise a physical downlink control channel (PDCCH) and a physical downlink shared channel (PDSCH).

A third aspect is a computer program product comprising a non-transitory computer readable medium, having thereon a computer program comprising program instructions. The computer program is loadable into a data processing unit and configured to cause execution of the method according to any of the first aspect and the second aspect when the computer program is run by the data processing unit.

A fourth aspect is an apparatus for power consumption control of a receiver configurable in different operational modes, wherein each of the operational modes is associated with a respective power consumption of the receiver, wherein at least two of the respective power consumptions are different, and wherein at least two of the operational modes have different hardware settings. The apparatus comprises controlling circuitry configured to cause selection of one of the operational modes for an upcoming reception occasion, wherein the selection of the operational mode is based on one or more selection parameters which include an expected modulation and coding scheme (MCS) for the upcoming reception occasion.

A fifth aspect is an apparatus for power consumption control of a receiver configurable in different operational modes, wherein each of the operational modes is associated with a respective power consumption of the receiver, wherein at least two of the respective power consumptions are different, and wherein at least two of the operational modes have different hardware settings. The apparatus comprises controlling circuitry configured to cause determination of a mapping scheme from one or more selection parameters to a collection of operational modes, wherein the one or more selection parameters include an expected modulation and coding scheme (MCS), and provision of the mapping scheme for use by the receiver in selecting one of the operational modes for a reception occasion.

A sixth aspect is a receiver comprising the apparatus of the first aspect and/or the second aspect.

A seventh aspect is a communication device comprising the receiver of the sixth aspect and/or the apparatus of the fourth aspect.

In some embodiments, the communication device is configured to be powered by a non-chargeable power source, and/or by energy harvesting.

An eighth aspect is a server node comprising the apparatus of the fifth aspect.

In some embodiments, any of the above aspects may additionally have features identical with or corresponding to any of the various features as explained above for any of the other aspects.

The embodiments described herein relate to methods (and corresponding apparatuses) for power consumption control of a receiver configurable in different operational modes, wherein at least two of the operational modes have different hardware settings.

However, it should be noted that it can-alternatively-be useful to consider the same methods (and corresponding apparatuses) for power consumption control of a receiver configurable in different operational modes, but letting the feature that at least two of the operational modes have different hardware settings be optional. For example, methods (and corresponding apparatuses) may be considered for power consumption control of a receiver configurable in different operational modes, wherein at least two of the operational modes define different numbers of reference signals (and/or different reference signal bandwidths) to be used for synchronization in preparation for the upcoming reception occasion.

An advantage of some embodiments is that new approaches are provided for power consumption control of receivers.

An advantage of some embodiments is that reduced power consumption is provided compared to other approaches.

An advantage of some embodiments is that acceptable reception performance is maintained.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a flowchart illustrating example method steps according to some embodiments;

FIG. 3 is a schematic block diagram illustrating an example apparatus according to some embodiments;

FIG. 4 is a schematic block diagram illustrating an example apparatus according to some embodiments; and

FIG. 5 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described for power consumption control of a receiver which is configurable in different operational modes. Each of the operational modes is associated with a respective power consumption of the receiver, and at least two of the respective power consumptions are different.

Some embodiments provide reduced power consumption compared to other approaches, while maintaining acceptable reception performance.

Some embodiments are particularly beneficial for communication devices powered by a source with limited and relatively low available energy (e.g., non-chargeable battery), and/or for communication devices powered by a fluctuating energy availability (e.g., energy harvesting).

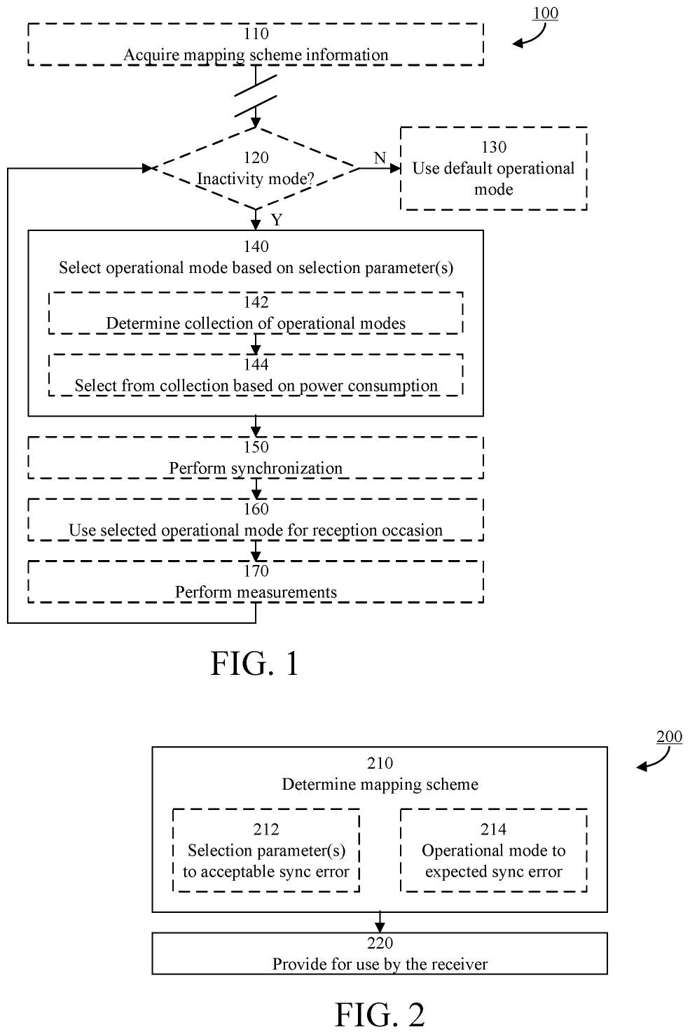

FIG. 1 illustrates an example method 100 according to some embodiments. The method 100 is for power consumption control of a receiver configurable in different operational modes.

For example, the method 100 may be performed by a communication device comprising the receiver; e.g., a user equipment (UE), or a radio access node (such as a base station, or a gNB).

Each of the operational modes is associated with a respective power consumption of the receiver, and at least two of the respective power consumptions are different.

Furthermore, at least two of the operational modes have different hardware settings. Different respective power consumptions of operational modes may be due to different hardware settings. For example, two operational modes which have different hardware settings may also have different respective power consumptions.

Generally, the hardware settings could be any suitable hardware settings. Typically, the hardware settings include hardware settings that enable variation of the power consumption of the receiver by variation of the value of the hardware setting.

For example, the hardware settings may include one or more of: local oscillator settings, phase-locked loop settings, analog-to-digital converter settings, antenna branch settings, low noise amplifier settings, clock rate settings, and baseband processing speed settings.

In some embodiments, a first operational mode has a first respective power consumption which is lower than a second respective power consumption of a second operational mode responsive to one or more of:
a local oscillator stability being lower for the first operational mode than for the second operational mode,
a local oscillator phase noise being higher for the first operational mode than for the second operational mode,
a phase-locked loop precision being lower for the first operational mode than for the second operational mode,
an analog-to-digital converter dynamic range being lower for the first operational mode than for the second operational mode,
an analog-to-digital converter sampling rate being lower for the first operational mode than for the second operational mode,
an analog-to-digital converter resolution being lower for the first operational mode than for the second operational mode,
a number of active antenna branches being lower for the first operational mode than for the second operational mode,
a low noise amplifier linearity being lower for the first operational mode than for the second operational mode,
a low noise amplifier noise figure being higher for the first operational mode than for the second operational mode,
a low noise amplifier sensitivity being lower for the first operational mode than for the second operational mode,
a clock rate being lower for the first operational mode than for the second operational mode, and
a baseband processing speed being lower for the first operational mode than for the second operational mode.

In some embodiments, at least two of the operational modes define different numbers of reference signals to be used for synchronization in preparation for the upcoming reception occasion. Typically, but not necessarily, at least one reference signal is used for synchronization in preparation for the upcoming reception occasion. Different respective power consumptions of operational modes may be due to different numbers of reference signals being used for synchronization in preparation for the upcoming reception occasion. For example, two operational modes which have different numbers of reference signals being used for synchronization in preparation for the upcoming reception occasion may also have different respective power consumptions. Example reference signals include synchronization signal block (SSB), tracking reference signal (TRS), and channel state information reference signal (CSI-RS).

Generally, a reference signal being used for synchronization in preparation for an upcoming reception occasion typically implies that the reference signal is received; and processed for synchronization purposes according to any suitable approach.

Alternatively or additionally, at least two of the operational modes may define different reference signal bandwidths to be used for synchronization in preparation for the upcoming reception occasion. Different respective power consumptions of operational modes may be due to different reference signal bandwidths to be used for synchronization in preparation for the upcoming reception occasion. For example, two operational modes which have different reference signal bandwidths to be used for synchronization in preparation for the upcoming reception occasion may also have different respective power consumptions.

Various combinations of the above are also possible. In one example, at least two of the operational modes have different hardware settings, define different numbers of reference signals to be used for synchronization in preparation for the upcoming reception occasion, and have different respective power consumptions. For example, one operational mode may have hardware settings that entails relatively low power consumption and define a relatively large number of reference signals to be used for synchronization, while another operational mode may have hardware settings that entails relatively high power consumption and define a relatively small number of reference signals to be used for synchronization. In one example, at least two of the operational modes have different hardware settings, define different reference signal bandwidths to be used for synchronization in preparation for the upcoming reception occasion, and have different respective power consumptions. In one example, at least two of the operational modes have different hardware settings, define different numbers of reference signals and different reference signal bandwidths to be used for synchronization in preparation for the upcoming reception occasion, and have different respective power consumptions.

A relatively low power consumption for the receiver can be obtained by using an operational mode with hardware settings that entail relatively low power consumption, and/or relatively few reference signals for synchronization, and/or relatively narrow reference signal bandwidth for synchronization. On the other hand, such an operational mode may also entail degraded reception performance (e.g., increased probability of missed detection, and/or increased probability of error in demodulation/decoding). One purpose of some embodiments, is to control this tradeoff in the selection of operational mode of the receiver; e.g., such that the power consumption is at a relatively low level, while maintaining acceptable reception performance.

As illustrated by step 140, the method comprises selecting one of the operational modes for an upcoming reception occasion based on one or more selection parameters.

The one or more selection parameters include an expected modulation and coding scheme (MCS) for the upcoming reception occasion.

In one example, the expected MCS is a known MCS. For example, the expected MCS may be a MCS stipulated by standardization documents for the applicable type of communication (e.g., technical specifications issued by the Third Generation Partnership Project, 3GPP). In some embodiments, the known MCS is a predefined MCS (e.g., stipulated by standardization documents for the applicable type of communication) for a known channel type of the upcoming reception occasion. For example, the physical downlink control channel (PDCCH) should always use quadrature phase shift keying (QPSK) according to some 3GPP technical specifications, so it can be assumed that any MCS specifying another modulation type than QPSK is not an expected MCS.

In one example, the expected MCS is a MCS of a previous reception occasion. For example, the expected MCS may be the MCS of a directly preceding reception occasion.

In one example, the expected MCS is a worst case MCS. For example, the expected MCS may be the least robust MCS that can occur for the upcoming reception occasion.

In some embodiments, the one or more selection parameters may further include one or more of: an expected numerology for the upcoming reception occasion, an expected sub-carrier spacing for the upcoming reception occasion, an expected cyclic prefix length for the upcoming reception occasion, a mobility state of the receiver, and an expected signal quality for the upcoming reception occasion. Example metrics indicating signal quality include: signal-to-interference ratio (SIR), signal-to-interference-and-noise ratio (SINR), received signal strength indicator (RSSI), reference signal received power (RSRP), reference signal received quality (RSRQ), Doppler shift, and Doppler spread. In some embodiments, the expected signal quality may be seen as an expression of an expected link quality.

As illustrated by optional step 170, the method 100 may comprise performing measurements to determine the value of one or more selection parameters. The measurements may be performed during a reception occasion, or between reception occasions (as suitable). Typically, parameter value(s) determined by measurements performed during one reception occasion may be used for one or more subsequent reception occasion (i.e., one or more of the selection parameters used in step 140 may have been determined by measurements performed during a previous reception occasion).

The measurements of step 170 may be any suitable measurements. For example, the measurements may be for determining the expected signal quality as exemplified above. Alternatively or additionally, the measurements may be for determining a mobility state of the receiver (e.g., stationary, low speed, or high speed).

The selection of step 140 may be based on synchronization error considerations. For example, the reception performance may depend on the synchronization error that occurs when an operation mode is used. Therefore, selection of operational mode with the aim to have relatively low power consumption while maintaining acceptable reception performance, could benefit from considering synchronization error.

Typically, hardware settings with low power consumption entails larger synchronization errors than hardware settings with high power consumption. Similarly, using a small number of reference signals for synchronization (i.e., low power consumption) typically entails larger synchronization errors than using a large number of reference signals for synchronization, and using a narrow reference signal bandwidth for synchronization (i.e., low power consumption) typically entails larger synchronization errors than using a wide reference signal bandwidth for synchronization.

Generally, a synchronization error can relate to an error in one or more of: time synchronization, frequency synchronization, and phase synchronization.

In some typical embodiments, each of the operational modes has an expected synchronization error. For example, the expected synchronization error may be a worst case synchronization error that can occur for the operational mode (e.g., hardware settings, and number of reference signals and reference signal bandwidth to be used for synchronization). The worst case synchronization error defines a range of possible synchronization errors that might occur for the operational mode.

Furthermore, the one or more selection parameters are associated with an acceptable synchronization error. For example, the acceptable synchronization error may be a maximum synchronization error that yields acceptable reception performance for the selection parameter(s). Typically, a relatively robust MCS is associated with a relatively large acceptable (time and/or frequency) synchronization error, a relatively large sub-carrier spacing is associated with a relatively large acceptable frequency synchronization error (wherein the acceptable frequency synchronization error is, for example, expressed in relative terms), a relatively long cyclic prefix is associated with a relatively large acceptable time synchronization error, a relatively low speed of the receiver is associated with a relatively large acceptable (time and/or frequency) synchronization error, a relatively high signal quality is associated with a relatively large acceptable (time and/or frequency) synchronization error, and a relatively small delay spread is associated with a relatively small acceptable time synchronization error.

Generally, a synchronization error be expressed in absolute terms (e.g., in Hz for a frequency synchronization error and in seconds for a time synchronization error) or in relative terms (e.g., as a portion of the carrier frequency—or any other suitable frequency unit—for a frequency synchronization error and as a portion of a symbol duration—or any other suitable time unit—for a time synchronization error).

In some embodiments, step 140 may comprise selecting the operational mode such that the expected synchronization error of the selected operational mode is smaller than, or equal to, the acceptable synchronization error for the one or more selection parameters.

This can be achieved by determining a collection of operational modes with expected synchronization error smaller than, or equal to, the acceptable synchronization error of the one or more selection parameters, as illustrated by optional substep 142, and selecting one of the operational modes of the collection, as illustrated by optional substep 144.

For example, substep 144 may comprise selecting the operational mode which is associated with a lowest power consumption in the collection, or selecting one of the operational modes of the collection which has a power consumption that is lower than a power consumption threshold.

For example, substep 142 may comprise mapping (e.g., using a look-up table) the selection parameter value(s) to an expected synchronization error, and mapping (e.g., using a look-up table) the expected synchronization error to the collection of operational modes as described above.

In some embodiments, the expected synchronization error may be compensated based on a time duration since a previous synchronization event before being mapped to the collection of operational modes. This is because, if a relatively long time has passed since a previous synchronization event, the expected synchronization error may be expected to be relatively large, while if a relatively short time has passed since a previous synchronization event, the expected synchronization error may be expected to be relatively small.

Alternatively or additionally, the mapping of the selection parameter value(s) to an expected synchronization error may be dependent on the hardware settings applied since a previous synchronization event. This is because, if a relatively high precision hardware setting has been used since a previous synchronization event, the expected synchronization error may be expected to be relatively small, while if a relatively low precision hardware setting has been used since a previous synchronization event, the expected synchronization error may be expected to be relatively large.

In some embodiments, the reception occasion comprises two or more physical channels (e.g., a physical downlink control channel, PDCCH, and a physical downlink shared channel, PDSCH). In such cases, associations between the selection parameter(s) and the operational modes may be determined by separate handling of the physical channels, averaging over the physical channels, or worst case analysis over the physical channels.

In one example, step 140 may be performed separately for each of the physical channels, resulting in separate (possibly different) selected operational modes for the physical channels. In one example, step 140 may be performed separately for each of the physical channels, resulting in separate intermediately selected operational modes for the physical channels, wherein the intermediately selected operational mode that is most robust (e.g., which has the smallest expected synchronization error) is selected as a common operational mode for the physical channels. In one example, step 140 may be performed jointly for each of the physical channels (e.g., using an average acceptable synchronization error and/or an average expected synchronization error).

It should be noted that different considerations may apply depending on which physical channel is considered. For example, PDCCH can have a varying aggregation level, the value of which could be included as a selection parameter.

In one example, step 140 may involve selecting operational modes such that a minimum power consumption is achieved for the combination of reception of paging PDCCH and reception of paging PDSCH. This may be beneficial, for example, when there is at least one reference signal available between paging PDCCH and paging PDSCH. Then, the receiver may stay in inactivity mode relatively long, use just one SSB for synchronization before performing reception in the PDCCH paging occasion, and use at least one additional reference signal for further synchronization between the PDCCH paging occasion and the PDSCH paging occasion.

When the operational mode has been selected in step 140, the method typically proceeds to use the selected operational mode for the reception occasion, as illustrated by optional step 160, possibly after performing synchronization according to the selected operational mode, as illustrated by optional step 150.

The expected synchronization error for an operational mode and/or the acceptable synchronization error for specific selection parameter value(s) may have been determined before execution of the method 100 (e.g., during manufacturing, by simulation, by test measurements, etc.). As illustrated by optional step 110, the method 100 may comprise acquiring mapping scheme information which specifies the expected synchronization error for an operational mode and/or the acceptable synchronization error for specific selection parameter value(s). Step 110 is typically performed relatively seldom (e.g., initially at manufacturing or setup of the device performing the method 100, and possibly with periodical and/or event-triggered updates). Step 110 may comprise determining the mapping scheme information, or receiving the mapping scheme information as determined by another device. The mapping scheme information may, according to some embodiments, be determined by performance of the method 200 (to be described later herein in connection with FIG. 2).

The method 100 is particularly beneficial when the receiver aims to conserve power. For example, the method 100 may be used by communication devices powered by a source with limited and relatively low available energy, and/or by communication devices powered by a fluctuating energy availability.

Alternatively or additionally, the method 100 may be used by communication devices that are configured to apply an inactivity mode (e.g., to conserve power and/or reduce overhead signaling).

In some embodiments, performance of one or more steps of the method 100 is conditioned on that the receiver is in an inactivity mode. For example, one or more steps of the method 100 may be triggered when there is an upcoming reception occasion while the receiver is in an inactivity mode. This is exemplified by optimal steps 120 and 130. In step 120 it is determined whether or not the receiver is in an inactivity mode. If the receiver is in an inactivity mode (Y-path out of step 120), the method proceeds to step 140 for selection of operational mode based on selection parameters. If the receiver is not in an inactivity mode (N-path out of step 120), the method proceeds to step 130, where a default operational mode is used for reception. The default operation mode may (or may not) coincide with one of the operational modes considered for selection in step 140.

Examples of inactivity modes include non-connected modes, inactive modes (e.g., RRC_INACTIVE), idle modes (e.g., RRC_IDLE), sleep modes, deep sleep modes, non-reception portions of discontinuous reception (DRX) modes, off-durations of discontinuous reception (DRX) modes, dormancy modes (e.g., secondary cell, SCell, dormancy in carrier aggregation, CA, scenarios), etc. To this end, the reception occasion may be (directly) preceded by an inactivity mode of the receiver. For example, the reception occasion may comprise a paging occasion, a random access resource, or a system information resource (e.g., for downlink control information, DCI).

It should be noted, however, that application of the method 100 is not limited to these circumstances. Contrarily, the method 100 may be applied for power consumption control in any circumstances where a receiver is configurable in different operational modes associated with respective power consumptions of the receiver.

FIG. 2 illustrates an example method 200 according to some embodiments. The method 200 is for power consumption control of a receiver configurable in different operational modes.

For example, the method 200 may be performed by a communication device comprising the receiver (e.g., as part of step 110 of the method 100 described in connection with FIG. 1).

Alternatively, the method 200 may be performed by a different device than the communication device comprising the receiver. In this case, mapping scheme information determined by performance of the method 200 may be provided to, and received by, the communication device comprising the receiver (e.g., reception of the mapping scheme information may be part of step 110 of the method 100 described in connection with FIG. 1).

Generally, the method 200 may, for example, be performed by a user equipment (UE), a radio access node (e.g., a base station, gNB, etc.), a central network node, or one or more server nodes (e.g., performing the method 200 in a distributed manner, such as using cloud processing).

In the same manner as described in connection with FIG. 1, each of the operational modes is associated with a respective power consumption of the receiver, at least two of the respective power consumptions are different, and at least two of the operational modes have different hardware settings. Furthermore, features and examples described in connection with the method 100 of FIG. 1 may be equally applicable (mutatis mutandis) for the method 200 of FIG. 2, even if not explicitly mentioned in connection thereto; and vice versa.

As illustrated by step 210, the method comprises determining a mapping scheme from one or more selection parameters (including an expected MCS) to a collection of operational modes. For example, such a mapping scheme may be used in substep 142 of FIG. 1.

The mapping scheme determination of step 210 may be performed once, or the mapping scheme may be re-determined/updated periodically and/or based on triggering events.

Example triggering events include that new possible values of selection parameters are introduced, that new receiver operational modes are introduced, and that changed channel conditions are detected, indicated, or suspected (e.g., based on deteriorating performance).

In some embodiments, step 210 also comprises determining the respective power consumption of the receiver for each of the operational modes. For example, the respective power consumption may be used in substep 144 of FIG. 1.

As illustrated by step 220, information pertaining to the mapping scheme (and an indication of the respective power consumption, when applicable) is provided for use by the receiver in the process of selecting one of the operational modes for a reception occasion. For example, the information pertaining to the mapping scheme may comprise one or more look-up tables.

The provision of step 220 may be performed once (e.g., provision to a storing medium where it can be accessed by receiver devices), once per receiver (e.g., at manufacturing or setup of the receiver), or repeatedly (e.g., when the mapping scheme is re-determined updated). Furthermore, step 220 may be performed for each execution of step 210 (e.g., in direct connection thereto), or may be performed more seldom, or more often, than step 210.

Generally, the determination in step 210 may be performed using any suitable approach (e.g., using simulation and/or test measurements, wherein the test measurements may, for example, be obtained during production testing and/or field testing).

In some typical embodiments, step 210 comprises determining a mapping from selection parameters to an acceptable synchronization error (as illustrated by optional substep 212), and a mapping from operational mode to an expected synchronization error (as illustrated by optional substep 214). It should be noted that this is merely an example approach for the mapping scheme, and that other approaches for the mapping scheme are equally possible (e.g., a direct mapping from selection parameter value(s) to a selected operational mode, or to a collection of operational modes that are suitable for the selection parameter value(s)).

In one example, substep 212 comprises hypothesizing all possible combinations of values of the selection parameter(s) and finding, for each hypothesis, a largest synchronization error that meets a criterion for acceptable performance (e.g., being below a threshold for probability of missed detection, and/or being below a threshold for probability of error in demodulation/decoding). Finding the largest synchronization error that meets the criterion for acceptable performance may, for example, comprise testing (e.g., performing simulations/calculations/measurements for) a set of different synchronization errors and compare the resulting reception performance (possibly in a plurality of scenarios) with the criterion for acceptable performance to find the largest synchronization error in the set that meets the criterion. The plurality of scenarios may, for example, relate to different channel conditions. The resulting reception performance may, for example, be a best performance obtained among the scenarios, a worst performance obtained among the scenarios, an average performance obtained for the scenarios, or any other suitable function of the performance obtained for the scenarios.

Generally, substep 212 may result in a look-up table mapping values of the selection parameter(s) to corresponding acceptable synchronization error.

In one example, substep 214 comprises testing (e.g., performing simulations/calculations/measurements for) all possible operational modes and finding, for each operational mode, a largest occurring synchronization error. This process may be combined with determination of the respective power consumption of the receiver for each of the operational modes.

Generally, substep 214 may result in a look-up table mapping operational mode to corresponding expected synchronization error.

Suitable margins may be applied in either or both of substeps 212 and 214 (e.g., to accommodate variations in device manufacturing, mobility, time/frequency/phase drift affecting the synchronization error, etc.).

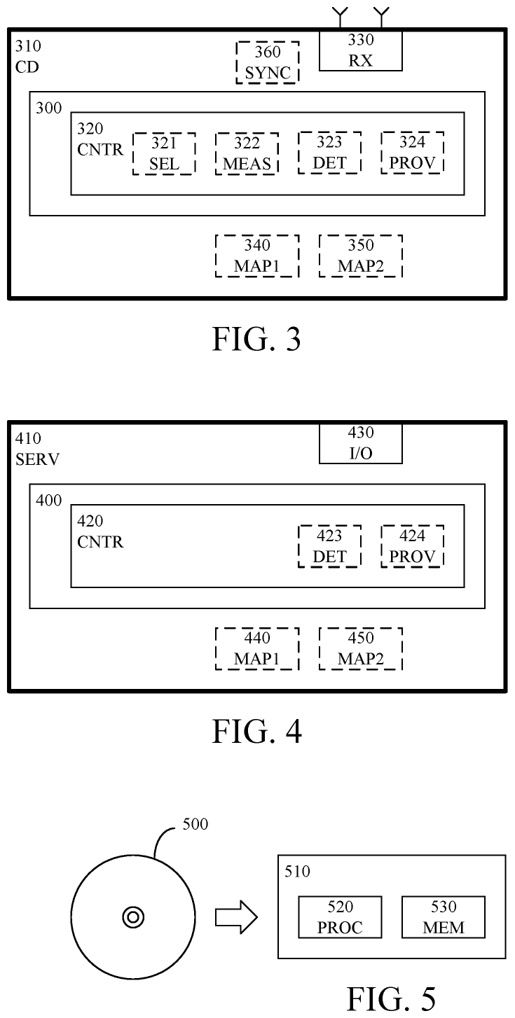

FIG. 3 schematically illustrates an example apparatus 300 according to some embodiments.

The apparatus 300 is an apparatus for power consumption control of a receiver (RX; e.g., receiving circuitry or a reception module) 330 configurable in different operational modes, wherein each of the operational modes is associated with a respective power consumption of the receiver, wherein at least two of the respective power consumptions are different, and wherein at least two of the operational modes have different hardware settings.

The apparatus 300 may be comprised in, or otherwise associated with (e.g., connected, or connectable, to) the receiver 330. In some embodiments, the apparatus 300 is comprisable (e.g., comprised) in a communication device (CD; e.g., a UE or a radio access node) 310, which may also comprise the receiver 330. For example, the communication device 310 may be configured to be powered (only) by a non-chargeable power source and/or by energy harvesting.

Alternatively or additionally, the apparatus 300 may be configured to cause performance of (e.g., perform) one or more steps of the method 100 in FIG. 1 and/or one or more steps of the method 200 in FIG. 2.

The apparatus 300 comprises a controller (CNTR; e.g., controlling circuitry or a control module) 320.

The controller 320 is configured to cause selection of one of the operational modes for an upcoming reception occasion (compare with step 140 of FIG. 1). The selection of the operational mode is based on one or more selection parameters which include an expected modulation and coding scheme (MCS) for the upcoming reception occasion.

To this end, the controller 320 may comprise, or be otherwise associated with (e.g., connected, or connectable, to) a selector (SEL; e.g., selecting circuitry or a selection module) 321. The selector 321 may be configured to select the operational mode for an upcoming reception occasion.

The controller 320 may also be configured to cause performance of measurements to determine selection parameter value(s) (compare with step 170 of FIG. 1).

To this end, the controller 320 may comprise, or be otherwise associated with (e.g., connected, or connectable, to) a measurer (MEAS; e.g., measuring circuitry or a measurement module) 322. The measurer 322 may be configured to perform measurements to determine selection parameter value(s).

The controller 320 may also be configured to cause performance of synchronization (compare with step 150 of FIG. 1).

To this end, the controller 320 may comprise, or be otherwise associated with (e.g., connected, or connectable, to) a synchronizer (SYNC; e.g., synchronizing circuitry or a synchronization module) 360. The synchronizer 360 may be configured to perform the synchronization.

The controller 320 may also be configured to cause use of the selected operational mode for reception via the receiver 330 (compare with step 160 of FIG. 1).

The controller 320 may also be configured to cause selection of the operational mode responsive to the receiver 330 being in an inactivity mode (compare with Y-path out of step 120 of FIG. 1), and to cause a default operational mode to be used otherwise (compare with step 130 and N-path out of step 120 of FIG. 1).

For example, the controller 320 may be configured to cause selection of one of the operational modes by causing determination of a collection of operational modes with expected synchronization error smaller than, or equal to, the acceptable synchronization error of the one or more selection parameters (compare with step 142 of FIG. 1), and selection of one of the operational modes of the collection (compare with step 144 of FIG. 1). Thus, the selector 321 may be configured to select the operational mode by determining a collection of operational modes with expected synchronization error smaller than, or equal to, the acceptable synchronization error of the one or more selection parameters, and select one of the operational modes of the collection.

To this end, the controller 320 may comprise, or be otherwise associated with (e.g., connected, or connectable, to) storage (e.g., storing circuitry) 340, 350 configured to accommodate a mapping (MAP1) from selection parameters to an acceptable synchronization error and a mapping (MAP2) from operational mode to an expected synchronization error.

The controller 320 may also be configured to cause acquisition of mapping scheme information (compare with step 110 of FIG. 1).

In some embodiments, the controller 320 is configured to cause reception of the mapping scheme information (e.g., via the receiver 330).

In some embodiments, the controller 320 is configured to cause determination of the mapping scheme information (compare with step 210 of FIG. 2). In some embodiments, the controller 320 is also configured to cause determination of respective power consumption of the receiver for each of the operational modes.

To this end, the controller 320 may comprise, or be otherwise associated with (e.g., connected, or connectable, to) a determiner (DET; e.g., determining circuitry or a determination module) 323. The determiner 323 may be configured to determine the mapping scheme information (and the respective power consumption of the receiver; when applicable).

In some embodiments, the controller 320 is configured to cause provision of the mapping scheme information (compare with step 220 of FIG. 2); e.g., to the storage 340, 350.

To this end, the controller 320 may comprise, or be otherwise associated with (e.g., connected, or connectable, to) a provider (PROV; e.g., providing circuitry or a provision module) 324. The provider 324 may be configured to provide the mapping scheme information.

FIG. 4 schematically illustrates an example apparatus 400 according to some embodiments.

The apparatus 400 is an apparatus for power consumption control of a receiver (e.g., the receiver 330 of FIG. 3) configurable in different operational modes, wherein each of the operational modes is associated with a respective power consumption of the receiver, wherein at least two of the respective power consumptions are different, and wherein at least two of the operational modes have different hardware settings.

In some embodiments, the apparatus 400 is comprisable (e.g., comprised) in a server node (SERV; e.g., central network node, or a cloud server) 410.

Alternatively or additionally, the apparatus 400 may be configured to cause performance of (e.g., perform) one or more steps of the method 200 in FIG. 2.

The apparatus 400 comprises a controller (CNTR; e.g., controlling circuitry or a control module) 420.

The controller 420 is configured to cause determination of a mapping scheme from one or more selection parameters to a collection of operational modes (compare with step 210 of FIG. 2). In some embodiments, the controller 420 is also configured to cause determination of respective power consumption of the receiver for each of the operational modes.

To this end, the controller 420 may comprise, or be otherwise associated with (e.g., connected, or connectable, to) a determiner (DET; e.g., determining circuitry or a determination module) 423. The determiner 423 may be configured to determine the mapping scheme information (and the respective power consumption of the receiver; when applicable).

For example, the mapping scheme information may comprise a mapping (MAP1) from selection parameter value(s) to acceptable synchronization error (compare with step 212 of FIG. 2) and a mapping (MAP2) from operational mode to expected synchronization error (compare with step 214 of FIG. 2).

The controller 420 is also configured to cause provision of the mapping scheme (and the respective power consumption of the receiver; when applicable) for use by the receiver in selecting one of the operational modes for a reception occasion (compare with step 220 of FIG. 2).

To this end, the controller 420 may comprise, or be otherwise associated with (e.g., connected, or connectable, to) a provider (PROV; e.g., providing circuitry or a provision module) 424. The provider 424 may be configured to provide the mapping scheme information.

For example, the mapping scheme information may be provided to storage (e.g., storing circuitry) 440, 450 comprised in the server node 410. Alternatively or additionally, the mapping scheme information may be provided to another device (e.g., the communication device 310 of FIG. 3, another server node where it can be accessed by receiver devices, or a storing medium where it can be accessed by receiver devices) via an interface (I/O; e.g., interface circuitry or an interface module) 430 of the server node 410.

Generally, it should be noted that features and examples described in connection with one of the Figures herein may be equally applicable (mutatis mutandis) for one or more of the other Figures herein, even if not explicitly mentioned in connection thereto. For example, features and examples described in connection with the method 100 of FIG. 1 may be equally applicable for the apparatus 300 of FIG. 3, and features and examples described in connection with the method 200 of FIG. 2 may be equally applicable for the apparatus 300 of FIG. 3 and/or for the apparatus 400 of FIG. 4.

Some embodiments may be particularly applicable for new radio (NR) as advocated by 3GPP. More particularly, some embodiments may be particularly applicable for paging in NR.

In that context, a UE in RRC_IDLE state or RRC_INACTIVE state operates in a so-called discontinuous reception (DRX) mode enabling it to save power, and paging message uses a combination of PDCCH and PDSCH; similarly to transmission of scheduled data in the downlink (DL). Paging signaling is specified to be quasi-collocated with synchronization signaling (i.e., with a synchronization signal block; SSB). Thus, a UE that receives an SSB using a certain receiver configuration (e.g., spatial reception, time/frequency offsets, etc.) can generally assume that the same receiver configuration is suitable for paging reception.

A NR UE typically carries out channel estimates on one or more SSB(s) prior to the paging occasion to acquire accurate time/frequency synchronization and be able to receive the paging signaling properly. The number of SSBs that are required for channel estimation may depend, for example, on coverage as perceived by the UE, whether the reception is PDCCH only or both PDCCH and PDSCH, the hardware architecture (e.g., the number of receiver chains), etc. The SSB(s) may be seen as an example of reference signal(s), the channel estimates may be seen as examples of synchronization, and the paging occasion may be seen as an example of reception occasion.

In many situations, a NR UE experiences a signal quality (e.g., SINR) that is rather high. Therefore, much of the operation relating to SSB(s) prior to the paging occasion can be excessive; particularly because the UE can typically decode paging successfully even if the synchronization error is rather high (e.g., higher than for data decoding). The power consumption of the UE can be unnecessarily high when an excessive amount of SSB(s) are used for synchronization before a paging occasion.

Alternatively or additionally, the power consumption of the UE can be unnecessarily high during paging when hardware components with high precision sampling are used to reduce synchronization errors; particularly because the UE can typically decode paging successfully even if the synchronization error is rather high.

Hence, some embodiments may be particularly useful in the context of a NR UE performing paging reception.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a communication device or a server node.

Embodiments may appear within an electronic apparatus (such as a communication device or a server node) comprising arrangements, circuitry, and/or logic according to any of the embodiments described herein. Alternatively or additionally, an electronic apparatus (such as a communication device or a server node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC; e.g., a data processing unit) 520, which may, for example, be comprised in a communication device or a server node 510. When loaded into the data processor, the computer program may be stored in a memory (MEM) 530 associated with, or comprised in, the data processor. According to some embodiments, the computer program may, when loaded into, and run by, the data processor, cause execution of method steps according to, for example, any of the methods illustrated in FIGS. 1 and 2, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-47. (canceled)

48. A method for power consumption control of a receiver configurable in different operational modes, wherein each of the operational modes is associated with a respective power consumption of the receiver, wherein at least two of the respective power consumptions are different, and wherein at least two of the operational modes have different hardware settings, the method comprising:
selecting one of the operational modes for an upcoming reception occasion, wherein the selection of the operational mode is based on one or more selection parameters which include an expected modulation and coding scheme (MCS) for the upcoming reception occasion.

49. The method of claim 48, wherein the expected MCS is a predefined MCS for a known channel type of the upcoming reception occasion.

50. The method of claim 48, wherein the one or more selection parameters further include one or more of: an expected numerology for the upcoming reception occasion, an expected sub-carrier spacing for the upcoming reception occasion, and an expected cyclic prefix length for the upcoming reception occasion.

51. The method of claim 48, wherein the one or more selection parameters further include a mobility state of the receiver.

52. The method of claim 48, wherein the one or more selection parameters further include an expected signal quality for the upcoming reception occasion.

53. The method of claim 48, wherein at least two of the operational modes define different numbers of reference signals to be used for synchronization in preparation for the upcoming reception occasion, and/or different reference signal bandwidths to be used for synchronization in preparation for the upcoming reception occasion.

54. The method of claim 48, wherein each of the operational modes has an expected synchronization error, wherein the one or more selection parameters are associated with an acceptable synchronization error, and wherein the expected synchronization error of the selected operational mode is smaller than, or equal to, the acceptable synchronization error of the one or more selection parameters.

55. The method of claim 54, wherein selecting one of the operational modes comprises:
determining a collection of operational modes with expected synchronization error smaller than, or equal to, the acceptable synchronization error of the one or more selection parameters; and
selecting one of the operational modes of the collection.

56. The method of claim 55, wherein selecting one of the operational modes of the collection comprises one or more of:
selecting the operational mode which is associated with a lowest power consumption in the collection; and
selecting one of the operational modes of the collection which has a power consumption that is lower than a power consumption threshold.

57. A method for power consumption control of a receiver configurable in different operational modes, wherein each of the operational modes is associated with a respective power consumption of the receiver, wherein at least two of the respective power consumptions are different, and wherein at least two of the operational modes have different hardware settings, the method comprising:
determining a mapping scheme from one or more selection parameters to a collection of operational modes, wherein the one or more selection parameters include an expected modulation and coding scheme (MCS); and
providing the mapping scheme for use by the receiver in selecting one of the operational modes for a reception occasion.

58. The method of claim 57, wherein the mapping scheme comprises a mapping from selection parameters to an acceptable synchronization error and a mapping from operational mode to an expected synchronization error.

59. The method of claim 57, further comprising:
determining the respective power consumption of the receiver for each of the operational modes; and
providing an indication of the respective power consumption for use by the receiver.

60. The method of claim 48, wherein the hardware settings include one or more of: local oscillator settings, phase-locked loop settings, analog-to-digital converter settings, antenna branch settings, low noise amplifier settings, clock rate settings, and baseband processing speed settings, and wherein a first operational mode has a first respective power consumption which is lower than a second respective power consumption of a second operational mode responsive to one or more of:
a local oscillator stability being lower for the first operational mode than for the second operational mode;
a local oscillator phase noise being higher for the first operational mode than for the second operational mode;
a phase-locked loop precision being lower for the first operational mode than for the second operational mode;
an analog-to-digital converter dynamic range being lower for the first operational mode than for the second operational mode;
an analog-to-digital converter sampling rate being lower for the first operational mode than for the second operational mode;
an analog-to-digital converter resolution being lower for the first operational mode than for the second operational mode;
a number of active antenna branches being lower for the first operational mode than for the second operational mode;
a low noise amplifier linearity being lower for the first operational mode than for the second operational mode;
a low noise amplifier noise figure being higher for the first operational mode than for the second operational mode;
a low noise amplifier sensitivity being lower for the first operational mode than for the second operational mode;
a clock rate being lower for the first operational mode than for the second operational mode; and
a baseband processing speed being lower for the first operational mode than for the second operational mode.

61. The method of claim 48, wherein the reception occasion is preceded by an inactivity mode of the receiver.

62. The method of claim 48, wherein the reception occasion comprises two or more physical channels, and wherein associations between the one or more selection parameters and the operational modes are determined by one or more of:
separate handling of the two or more physical channels;
averaging over the two or more physical channels; and
worst case analysis over the two or more physical channels.

63. An apparatus for power consumption control of a receiver configurable in different operational modes, wherein each of the operational modes is associated with a respective power consumption of the receiver, wherein at least two of the respective power consumptions are different, and wherein at least two of the operational modes have different hardware settings, the apparatus comprising controlling circuitry configured to cause:
selection of one of the operational modes for an upcoming reception occasion, wherein the selection of the operational mode is based on one or more selection parameters which include an expected modulation and coding scheme (MCS) for the upcoming reception occasion.

64. The apparatus of claim 70, wherein the expected MCS is a predefined MCS for a known channel type of the upcoming reception occasion.

65. An apparatus for power consumption control of a receiver configurable in different operational modes, wherein each of the operational modes is associated with a respective power consumption of the receiver, wherein at least two of the respective power consumptions are different, and wherein at least two of the operational modes have different hardware settings, the apparatus comprising controlling circuitry configured to cause:
determination of a mapping scheme from one or more selection parameters to a collection of operational modes, wherein the one or more selection parameters include an expected modulation and coding scheme (MCS); and
provision of the mapping scheme for use by the receiver in selecting one of the operational modes for a reception occasion.

66. The apparatus of claim 65, wherein the mapping scheme comprises a mapping from selection parameters to an acceptable synchronization error, and a mapping from operational mode to an expected synchronization error.

67. The apparatus of claim 65, wherein the controlling circuitry is further configured to cause:
determination of the respective power consumption of the receiver for each of the operational modes; and
provision of an indication of the respective power consumption for use by the receiver.
